(19) United States
(12) Patent Application Publication
(10) Pub. No.: US 2010/0288435 A1
(43) Pub. Date: Nov. 18, 2010

(54) METHOD FOR PRODUCING A POLYMER LAMINATE COMPRISING A PLASMA PROCESSING ACTIVATION STEP

(76) Inventors: Bruno D'herbecourt, Bernay (FR); Rene-Paul Eustache, Combon (FR); Florence Sache, Saint Aubin Le Vertueux (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/739,189

(22) PCT Filed: Oct. 21, 2008
(86) PCT No.: PCT/FR08/51892

§ 371 Date: Aug. 2, 2010

(30) Foreign Application Priority Data
Oct. 22, 2007 (FR) 0758474

(51) Int. Cl. B32B 37/12

(52) U.S. Cl. 156/272.6

(57) ABSTRACT

“The invention relates to a method for producing a laminate comprising at least two polymer layers, a layer (A) and a layer (B), which are fixed to each other by at least one aqueous-type adhesive polymer material layer (C). Said method is characterized in that: (a) it optionally consists of a step of pre-cleaning substrate layer (A) and/or substrate layer (B), by oxidizing or reducing continuous atmospheric cold plasma processing pre-cleaning; (b) the plasma is either (i) oxidizing or reducing when the layer is a polymer layer having a shore D of strictly between 35 and 60 or when the layer is a polymer layer having a shore D> or =60 and the distance between the plasma source and the surface of the layer to be activated is < or =3 cm, and (ii) the plasma is reducing when the layer is a polymer layer having a Shore D> or =60 and the distance between the plasma source and the surface of the layer to be activated >3 cm, substrate layers (A) and (B) being identical or different, and formed by non-exudant polymers.”

The present invention relates, generally, to a laminated product and in particular to the constituent components of a shoe, in particular a shoe sole, comprising at least two substrate layers, a layer of substrate (A) and a layer of substrate (B), said substrate layers being bonded to one another. The layer of substrate (A) and/or the layer of substrate (B) comprise at least one polymer, to which at least one filler may or may not be added, that does not exude and chosen from (i) polyamide (abbreviated to PA) homopolymers or copolymers, (ii) thermoplastic elastomers (abbreviated to TPEs), chosen from PEBAs or copolymers with polyamide blocks and polyether blocks, TPUs or thermoplastic polyurethane polymers, COPEs or copolymers having polyether blocks and polyester blocks and (iii) blends thereof. The polymers used to manufacture the layers of substrates (A) and (B) may be identical or different.

The layers of substrates (A) and (B) are bonded to one another by means of at least one layer of an aqueous-type adhesive material, that is to say either an adhesive material with a low content of organic solvent (<10 wt. % of solvent relative to the weight of the adhesive material) or an adhesive material that is free of organic solvent.

The present invention also relates to a process for manufacturing such a laminate and to its use in the shoe industry, especially for manufacturing constituent components of shoes, for example soles and most particularly soles of sports shoes.

Over the last ten years, materials based on PEBA copolymers, such as the materials sold by Arkema under the brand name Pebax®, have been progressively introduced into the field of top-of-the-range shoes, particularly sports shoes, thanks to their mechanical properties and especially their exceptional spring-back property.

Generally, the bonding of this type of substrate made from these PEBA materials, in order to produce a laminate, requires the following operations:

cleaning of the surfaces of the substrates to be bonded with an organic solvent such as methyl ethyl ketone (MEK),

applying, generally with a brush, a layer of primer composition to at least the contacting surface of the substrate;

drying the primer layer in an oven;

applying, generally with a brush, a layer of two-component polyurethane-type adhesive to the primer layer and also to the contacting surface of the other substrate;

drying the adhesive layers in an oven;

contacting the two adhesive-coated substrates; and

pressing the assembly resulting from the contacting operation.

Generally, the primer compositions used are of a two-component type and comprise:
a first component which is a functionalized resin in solution in an organic solvent; and
a second component which is an isocyanate or a mixture of isocyanates also in solution in an organic solvent and which has a crosslinking function. This component is also called a “curing agent”. It is added to the first component just before use.

The two-component adhesives themselves also comprise a first component which is a functionalized organic resin in dispersion or in solution in an organic solvent and/or in water and a second component also called a “curing agent”, which has a crosslinking function, and which is either at least one isocyanate, or a solution of at least one isocyanate in a solvent.

During the drying operations, both the primer compositions and the adhesives of the prior art result in the evaporation of a large amount of organic solvent. Thus, in the case of the manufacture of a laminate for a shoe, it is estimated that the average amount of adhesive used is 5 g and that of primer composition is 3 g for a shoe, and the amount of solvent emitted per shoe can be estimated to be 2.9 g. Taking a production of 10 000 shoes per day for a production unit, the total amount of solvent emitted by this unit is 29 kg per day.

Moreover, the quality of the bonding of the systems of the prior art (expressed by the peel strength of the substrates) is far from optimal. Thus, although peel strengths of around 6 to 6.5 daN/cm are obtained with substrates having a low hardness (Shore D <35) to average hardness (35 <Shore D<60), a peel strength of no more than around 3 daN/cm is obtained with substrates of high hardness (Shore D>60). Pebax® 55-1 is thus considered as a substrate of average hardness and Pebax® 70-1 is considered as a substrate of high hardness. However, the shoe manufacturers impose a peel strength of at least 3 daN/cm. It is therefore observed that the bonding with the systems of the prior art is not sufficient in the case of the hardest polymers (Shore D>60).

Furthermore, certain grades of polymers have a tendency to “exude”, that is to say that they generate a whitish deposit, that is more or less large depending on the grade, on the surface of finished parts. This deposit may correspond to the presence of additives, impurities or oligomers present in the polymer which “rise” to the surface of the parts over time. This deposit proves to be damaging within the context of bonding components together and hinders the correct operation of said bonding.

The object of the present invention is therefore to provide a process for manufacturing a laminate such as described above that overcomes the drawbacks of the prior art. This process has the advantage, in addition, of being able to be carried out continuously on a production line and of treating parts of constituent components of shoes that have a complex geometry with a 3-dimensional action.

A solution to these technical problems has now been found.

More particularly, a laminated product has now been successfully manufactured that comprises at least two substrate layers: a layer of substrate (A) and a layer of substrate (B) that adhere to one another by means of at least one aqueous-type adhesive polymer material with a peel strength compatible with the use of such a laminated product in the constituent components of shoes, said substrate layers possibly being completely or partially made of a polymer having average or high hardness (see definition above).

The nature of the substrate layers, of the adhesive polymer material and of the process for manufacturing the laminated product will be described below in greater detail.

### Regarding the Aqueous-Type Adhesive Polymer Material, Also Subsequently' Called Aqueous Adhesive (C):

The adhesive polymer material is a crosslinkable hot-melt material.

It is manufactured by the reaction of at least one functionalized prepolymer and at least one curing agent comprising free (—N═C═O) or blocked isocyanate functional groups. In the latter case, the reaction will be carried out after unblocking said functional groups, just before use of the adhesive material.

Reference is made to a two-component or single-component adhesive material depending on the case known to a person skilled in the art.

Generally, the content of the curing agent having free or blocked isocyanate functional groups represents 0.5 to 25% by weight, preferably 2 to 10% by weight relative to the total weight of the functionalized prepolymer.

In particular, the funetionalized prepolymers of the crosslinkable hot-melt materials suitable for the present invention are chosen from hydroxylated polyesters, hydroxylated polyethers and blends thereof.

The adhesive polymer material may also comprise one or more adjuvants in the usual proportions, such as for example:

stabilizers such as benzoyl chloride, phosphoric acid, acetic acid, p-toluenesulphonyl isocyanate; and

fillers.

### Regarding the Aqueous Primer:

The aqueous primer composition is chosen from those described above for the aqueous adhesives. However, it is rendered more fluid by formulations known to a person skilled in the art, this being for a better application to the substrate during its use.

The aqueous primers may also be two-component compositions, the first component being a dispersion of a hydroxylated organic resin in water and the second component being at least one polyisocyanate in an organic solvent.

It is also possible to use single-component aqueous primers, in particular systems based on blocked isocyanates that are rendered reactive by the action of an increase in temperature.

### Regarding the Substrates:

The layer of substrate (A) and/or (B) comprises at least one polymer. As polymer, mention may be made of PA homopolymers or copolymers, and thermoplastic elastomers, in particular block copolymers. By way of example of block copolymers, mention may be made of copolymers having polyester blocks and polyether blocks (abbreviated to COPEs and also called copolyether esters), copolymers having polyurethane blocks and polyether blocks or polyester blocks (also called TPUs, abbreviation of thermoplastic polyurethanes) and copolymers having polyamide blocks and polyether blocks (also called polyether-block-amides, abbreviated to PEBAs according to the IUPAC).

The expression “thermoplastic elastomer (TPE)” is understood to mean a block copolymer comprising, alternately, so-called hard or rigid blocks or segments and so-called soft or flexible blocks or segments.

By way of a copolymer having hard blocks and soft blocks, mention may respectively be made of (a) the copolymers having polyester blocks and polyether blocks (also known as COPEs or copolyether esters), (b) the copolymers having polyurethane blocks and polyether or polyester blocks (also known as TPUs, abbreviation for thermoplastic polyurethanes) and (c) the copolymers having polyamide blocks and polyether blocks (also known as PEBAs according to the IUPAC).

Regarding the COPEs or copolyether esters, these are copolymers with polyester blocks and polyether blocks. They are composed of soft polyether blocks derived from polyether diols and rigid polyester blocks which result from the reaction of at least one dicarboxylic acid with at least one short chain-extender diol unit. The polyester blocks and the polyether blocks are joined together by ester bonds resulting from the reaction of the acid functional groups of the dicarboxylic acid with the OH functional groups of the polyether diol. The chaining of the polyethers and diacids forms soft blocks whereas the chaining of glycol or of butanediol with the diacids forms the rigid blocks of the copolyether ester. The short chain-extender diol may be chosen from the group composed of neopentyl glycol, cyclohexanedimethanol and aliphatic glycols of formula HO(CH₂)ₙOH in which n is an integer ranging from 2 to 10.

Advantageously, the diacids are aromatic dicarboxylic acids having from 8 to 14 carbon atoms. Up to 50 mol % of aromatic dicarboxylic acid may be replaced by at least one other aromatic dicarboxylic acid having from 8 to 14 carbon atoms, and/or up to 20 mol % may be replaced by an aliphatic dicarboxylic acid having from 2 to 14 carbon atoms.

By way of example of aromatic dicarboxylic acids, mention may be made of terephthalic acid, isophthalic acid, dibenzoic acid, naphthalenedicarboxylic acid, 4,4′-diphenylenedicarboxylic acid, bis(p-carboxyphenyl)methane acid, ethylenebis(p-benzoic acid), 1,4-tetramethylenebis(p-oxybenzoic acid), ethylenebis(p-oxybenzoic acid) and 1,3-trimethylenebis(p-oxybenzoic acid).

By way of example of glycols, mention may be made of ethylene glycol, 1,3-trimethylene glycol, 1,4-tetramethylene glycol, 1,6-hexamethylene glycol, 1,3-propylene 1,8-oetamethylene glycol, 1,10-decamethylene glycol and 1,4-cyclohexylenedimethanol. The copolymers with polyester blocks and polyether blocks are, for example, copolymers having polyether units derived from polyether diols such as polyethylene glycol (PEG), polypropylene glycol (PPG), polytrimethylene glycol (PO3G) or polytetramethylene glycol (PTMG), dicarboxylic acid units such as terephthalic acid and glycol (ethanediol) or 1,4-butanediol units. Such copolyether esters are described in Patents EP 402 883 and EP 405 227. These polyether esters are thermoplastic elastomers. They may contain plasticizers.

Regarding the TPUs, mention may be made of the polyether urethanes which result from the condensation of soft polyether blocks which are polyether diols and rigid polyurethane blocks derived from the reaction of at least one diisocyanate which may be chosen from aromatic diisocyanates (e.g. MDI, TDI) and aliphatic diisocyanates (e.g. HDI or hexamethylenediisocyanate) with at least one short diol. The short chain-extender diol may be chosen from the glycols cited above in the description of the copolyether esters. The polyurethane blocks and the polyether blocks are joined together by bonds resulting from the reaction of the isocyanate functional groups with the OH functional groups of the polyether diol.

Mention may also be made of the polyester urethanes which result from the condensation of soft polyester blocks which are polyester diols and rigid polyurethane blocks derived from the reaction of at least one diisocyanate with at least one short diol. The polyester diols result from the condensation of dicarboxylic acids advantageously chosen from aliphatic dicarboxylic acids having from 2 to 14 carbon atoms and of glycols which are short chain-extender diols chosen from the glycols mentioned above in the descripition of the copolyether esters. They may contain plasticizers.

Regarding the PEBAs, they result from the polycondensation of polyamide blocks having reactive ends with polyether blocks having reactive ends, such as, amongst others:
1) polyamide blocks having diamine chain ends with polyoxyalkylene blocks having dicarboxyl chain ends;
2) polyamide blocks having dicarboxyl chain ends with polyoxyalkylene blocks having diamine chain ends, obtained by cyanoethylation and hydrogenation of aliphatic α,ω-dihydroxylated polyoxyalkylene blocks known as polyether diols; and
3) polyamide blocks having dicarboxyl chain ends with polyether diols, the products obtained being, in this particular case, polyether ester amides.

The polyamide blocks having dicarboxyl chain ends originate, for example, from the condensation of polyamide precursors in the presence of a dicarboxylic acid chain stopper.

The polyamide blocks having diamine chain ends originate, for example, from the condensation of polyamide precursors in the presence of a diamine chain stopper. The number-average molecular weight Mₙ, of the polyamide blocks is between 400 and 20 000 g/mol and preferably between 500 and 10 000 g/mol.

The polymers with polyamide blocks and polyether blocks may also comprise units distributed randomly.

Advantageously, three types of polyamide blocks can be used.

According to a first type, the polyamide blocks originate from the condensation of a dicarboxylic acid, in particular those having from 4 to 20 carbon atoms, preferably those having from 6 to 18 carbon atoms and an aliphatic or aromatic diamine, in particular those having from 2 to 20 carbon atoms, preferably those having from 6 to 14 carbon atoms.

By way of example of dicarboxylic acids, mention may be made of 1,4-cyclohexyldicarboxylic acid, butanedioic acid, adipic acid, azelaic acid, suberic acid, sebacic acid, dodecanedicarboxylic acid, octadecanedicarboxylic acid and terephthalic and isophthalic acids, but also dimerized fatty acids.

By way of example of diamines, mention may be made of tetramethylenediamine, hexamethylenediamine, 1,10-decamethylenediamine, dodecamethylenediamine, trimethylhexamethylenediamine, isomers of bis(4-aminocyclohexyl)methane (BACM), bis(3-methyl-4-aminocyclohexyl)methane (BMACM), and 2-2-bis(3-methyl-4-aminocyclohexyl)propane (BMACP), and para-aminodicyclohexylmethane (PACM), and isophoronediamine (IPDA), 2,6-bis(aminomethyl)norbornane (BAMN) and piperazine (Pip).

Advantageously, PA-4,12, PA-4,14, PA-4,18, PA-6,10, PA-6,12, PA-6,14, PA-6,18, PA-9,12, PA-10,10, PA-10,12, PA-10,14 and PA-10,18 blocks are available.

According to a second type, the polyamide blocks result from the condensation of one or more α,ω-aminocarboxylic acids and/or one or more lactams having from 6 to 12 carbon atoms in the presence of a dicarboxylic acid having from 4 to 12 carbon atoms or a diamine.

By way of example of lactams, mention may be made of caprolactam, oenanthollactam and lauryl lactam.

By way of example of α,ω-aminocarboxylic acids, mention may be made of aminocaproic, 7-aminoheptanoic, 11-aminoundecanoie and 12-aminododecanoic acids.

Advantageously, the polyamide blocks of the second type are made of polyamide PA-11, polyamide PA-12 or polyamide PA-6.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation of:
the linear aliphatic or aromatic diamine or diamines having X carbon atoms;
the dicarboxylic acid or acids having Y carbon atoms; and
the cotnonorner or comonomers {Z}, chosen from lactams and α,ω-aminocarboxylic acids having Z carbon atoms and the equimolar mixtures of at least one diamine having X1 carbon atoms and at least one dicarboxylic acid having Y1 carbon atoms, (X1, Y1) being different from (X, Y),
said comonomer or comonomers {Z} being introduced in a weight proportion ranging up to 50%, preferably up to 20%, even more advantageously up to 10% relative to the total of polyamide precursor monomers;
in the presence of a chain stopper chosen from dicarboxylic acids.

Advantageously, the dicarboxylic acid having Y carbon atoms is used as a chain stopper, which is introduced in excess relative to the stoichiometry of the diamine or diamines.

According to one variant of this third type, the polyamide blocks result from the condensation of at least two α,ω-aminocarboxylic acids or of at least two lactams having from 6 to 12 carbon atoms or of one lactam and one aminocarboxylic acid that do not have the same number of carbon atoms in the optional presence of a chain stopper.

By way of example of an aliphatic α,ω-aminocarboxylic acid, mention may be of aminocaproic, 7-aminoheptanoic, 11-aminoundecanoic and 12-aminododecanoic acids.

By way of example of a lactam, mention may be made of caprolactam, oenanthollactam and lauryl lactam.

By way of example of aliphatic diamines, mention may be made of hexamethylenediamine, dodecamethylenediamine and trimethylhexamethylenediamine.

By way of example of cycloaliphatic diacids, mention may be made of 1,4-cyclohexyldicarboxylie acid.

By way of example of aliphatic diacids, mention may be made of butanedioic, adipic, azelaic, suberic, sebacic and dodecanedicarboxylic acids, dimerised fatty acids (these dimerised fatty acids preferably have a dimer content of at least 98%; preferably they are hydrogenated; they are sold under the brand name PRIPOL by Uniqema or under the brand name EMPOL by Henkel) and α,ω-polyoxyalkylene diacids.

By way of example of aromatic diacids, mention may be made of terephthalic (T) and isophthalic (I) acids.

By way of example of cycloaliphatic diamines, mention may be of the isomers of bis(4-aminocyclohexyl)methane (BACM), bis(3-methyl-4-aminocyclohexyl)methane (BMACM), and 2-2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

By way of example of polyamide blocks of the third type, mention may be made of the following:
PA-6,6/6 in which 6,6 denotes hexamethylenediamine units condensed with adipic acid. 6 denotes units resulting from the condensation of caprolactam.
PA-6,6/Pip.10/12 in which 6,6 denotes hexamethylenediamine units condensed with adipic acid. Pip.10 denotes units resulting from the condensation of piperazine and sebacic acid. 12 denotes units resulting from the condensation of lauryl lactam.
   The weight proportions are respectively 25 to 35/20 to 30/20 to 30—the total being 80, and advantageously 30 to 35/22 to 27/22 to 27—the total being 80. For example the proportions 32/24/24 result in a melting point of 122 to 137° C.
PA-6,6/6,10/11/12 in which 6,6 denotes hexamethylenediamine condensed with adipic acid. 6,10 denotes hexamethylenediamine condensed with sebacic acid. 11 denotes units resulting from the condensation of aminoundecanoic acid. 12 denotes units resulting from the condensation of lauryl lactam.
   The weight proportions are respectively 10 to 20/15 to 25/10 to 20/15 to 25—the total being 70, and advantageously 12 to 16/18 to 25/12 to 16/18 to 25—the total being 70. For example, the proportions 14/21/14/21 result in a melting point of 119 to 131° C.

The polyether blocks may represent 5 to 85 wt % of the copolymer with polyamide and polyether blocks. The weight Mₙ of the polyether blocks is between 100 and 6000 g/mol and preferably between 200 and 3000 g/mol.

The polyether blocks are composed of alkylene oxide units. These units may be, for example, ethylene oxide units, propylene oxide units or tetrahydrofuran units (which results in polytetramethylene glycol linkages). Thus, use is made of PEG (polyethylene glycol) blocks, that is to say those composed of ethylene oxide units, PPG (propylene glycol) blocks, that is to say those composed of propylene oxide units, PO3G (polytrimethylene glycol) blocks, that is to say those composed of polytrimethylene ether glycol units (such copolymers with polytrimethylene ether blocks are described in Patent U.S. Pat. No. 6,590,065) and PTMG blocks, that is to say those composed of tetramethylene glycol units also known as polytetrahydrofuran blocks. Advantageously, use is made of PEG blocks or of blocks obtained by oxyethylation of bisphenols, such as for example bisphenol A. The latter products are described in Patent EP 613 919.

The polyether blocks may also be composed of ethoxylated primary amines. Advantageously, use is also made of these blocks. By way of example of ethoxylated primary amines, mention may be made of the products of formula:

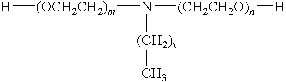

in which m and n are between 1 and 20 and x is between 8 and 18. These products are commercially available under the brand name NORAMOX® from CECA and under the brand name GENAMIN® from Clariant.

The ether units (A2) are, for example, derived from at least one polyalkylene ether polyol, especially a polyalkylene ether diol, preferably chosen from polyethylene glycol (PEG), polypropylene glycol (PPG), polytrimethylene glycol (PO3G), polytetramethylene glycol (PTMG) and blends thereof or copolymers thereof.

The soft polyether blocks may comprise polyoxyalkylene blocks having NH₂ chain ends, such blocks possibly being obtained by cyanoacetylation of aliphatic α,ω-dihydroxylated polyoxyalkylene blocks known as polyether diols. More particularly, it is possible to use Jeffamines (for example, Jeffamine® D400, D2000, ED 2003, XTJ 542, commercial products from Huntsman. See also Patents JP 2004346274, JP 2004352794 and EP 1 482 011).

The polyether diol blocks are either used as they are and copolycondensed with polyamide blocks having carboxylic ends, or they are aminated in order to be converted to polyether diamines and condensed with polyamide blocks having carboxylic ends. They may also be blended with polyamide precursors and a diacid chain stopper in order to make polymers having polyamide blocks and polyether blocks having randomly distributed units.

These polymers may be prepared by the simultaneous reaction of the polyether blocks and of the precursors of the polyamide blocks, preferably the polycondensation is carried out at a temperature of 180 to 300° C. For example, it is possible to react the polyether diol, the polyamide precursors and a diacid chain stopper. A polymer is obtained that mainly has polyether blocks and polyamide blocks of very variable length, but also, as the various reactants have reacted randomly, which are distributed randomly along the polymer chain.

It is also possible to react the polyetherdiamine, polyamide precursors and a diacid chain stopper. A polymer is obtained having mainly polyether blocks and polyamide blocks of very variable length, but also, as the various reactants have reacted randomly, which are distributed randomly along the polymer chain.

But they may also be advantageously prepared by the condensation reaction of the polyether blocks with the polyamide blocks.

The catalyst is defined as being any product that makes it possible to facilitate the bonding of the polyamide blocks and of the polyether blocks by esterification or by amidification. The esterification catalyst is advantageously a derivative of a metal chosen from the group formed by titanium, zirconium and hafnium or else a strong acid such as phosphoric acid or boric acid. Examples of catalysts are those described in Patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920.

The general method for the two-step preparation of PEBA copolymers having ester bonds between the PA blocks and PE blocks is known and is described, for example, in French Patent FR 2 846 332. The general method for preparing the PEBA copolymers of the invention having amide bonds between the PA blocks and the PE blocks is known and described, for example, in European Patent EP 1 482 011.

The reaction for forming the PA block is normally carried out between 180 and 300° C., preferably from 200 to 290° C., the pressure in the reactor is established between 5 and 30 bar, and it is maintained for around 2 to 3 hours. The pressure is slowly reduced by bringing the reactor to atmospheric pressure, then the excess water is distilled, for example over one or two hours.

Once the polyamide with carboxylic acid ends has been prepared, the polyether and a catalyst are then added. It is possible to add the polyether in one or more goes, likewise for the catalyst. According to one advantageous form, first the polyether is added, the reaction of the OH ends of the polyether and of the COOH ends of the polyamide begins with formation of ester bonds and removal of water. As much as possible of the water is removed from the reaction medium by distillation, then the catalyst is introduced to complete the bonding of the polyamide blocks and of the polyether blocks. This second step is carried out with stirring, preferably under a vacuum of at least 6 mmHg (800 Pa) at a temperature such that the reactants and the copolymers obtained are in the melt state. By way of example, this temperature may be between 100 and 400° C. and usually between 200 and 300° C. The reaction is followed by measurement of the torque exerted by the molten polymer on the stirrer or by measurement of the electrical power consumed by the stirrer. The end of the reaction is determined by the target value of the torque or of the power.

It is also possible to add, during the synthesis, at the moment judged the most opportune, one or more molecules used as an antioxidant, for example IRGANOX® 1010 or IRGANOX® 245.

Regarding the preparation of copolymers having polyamide blocks and polyether blocks, they may be prepared by any means that makes it possible to attach the polyamide blocks and polyether blocks. In practice, two processes are mainly used, one a 2-step process and the other a single-step process.

In the two-step process, the polyamide blocks are manufactured first then in a second step the polyamide blocks and the polyether blocks are attached. In the single-step process, the polyamide precursors, the chain stopper and the polyether are mixed; thus a polymer is obtained having mainly polyether blocks and polyamide blocks of very variable length, but also as the various reactants have reacted randomly, which are distributed randomly along the polymer chain. Whether it is a single-step or two-step process, it is advantageous to operate in the presence of a catalyst. It is possible to use the catalysts described in Patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920, WO 04 037898, EP 1 262 527, EP 1 270 211, EP 1 136 512, EP 1 046 675, EP 1 057 870, EP 1 155 065, EP 506 495 and EP 504 058. In the single-step process, polyamide blocks are also manufactured, which is why it was written at the beginning of this paragraph that these copolymers could be prepared by any means of attaching polyamide blocks (PA blocks) and polyether blocks (PE blocks).

Advantageously, the PEBA copolymers have PA blocks made of PA-6, PA-11, PA-12, PA-6,12, PA-6,616, PA-10,10 and PA-6,14 and PE blocks made of PTMG, PPG, PO3G and PEG.

Regarding the polyamides, these are homopolyamides or copolyamides.
According to a first type, the polyamides originate from the condensation of a dicarboxylic acid, in particular those having from 4 to 20 carbon atoms, preferably those having from 6 to 18 carbon atoms and an aliphatic or aromatic diamine, in particular those having from 2 to 20 carbon atoms, preferably those having from 6 to 14 carbon atoms.

By way of example of dicarboxylic acids, mention may be made of 1,4-cyclohexyldicarboxylic acid, butanedioic acid, adipic acid, azelaic acid, suberic acid, sebacic acid, dodecanedicarboxylic acid, octadecanedicarboxylic acid and terephthalic and isophthalic acids, but also dimerized fatty acids.

By way of example of diamines, mention may be made of tetramethylenediamine, hexamethylenediamine, 1,10-decamethylenediamine, dodecamethylenediamine, trimethylhexamethylenediamine, isomers of bis(4-aminocyclohexyl)methane (BACM), bis(3-methyl-4-aminocyclohexyl)methane (BMACM), and 2-2-bis(3-methyl-4-aminocyclohexyl)propane (BMACP), and para-aminodicyclohexylmethane (PACM), and isophoronediamine (IPDA), 2,6-bis(aminomethyl)norbornane (BAMN) and piperazine (Pip).

Advantageously, PA-4,12, PA-4,14, PA-4,18, PA-6,10, PA-6,12, PA-6,14, PA-6,18, PA-9,12, PA-10,10, PA-10,12, PA-10,14 and PA-10,18 blocks are available.
According to a second type, the polyamides result from the condensation of one or more α,ω-aminocarboxylic acids and/or one or more lactams having from 6 to 12 carbon atoms in the presence of a dicarboxylic acid having from 4 to 12 carbon atoms or a diamine.

By way of example of lactams, mention may be made of caprolactam, oenanthollactam and lauryl lactam.

By way of example of α,ω-aminocarboxylic acids, mention may be made of aminocaproic, 7-aminoheptanoic, 11-aminoundecanoic and 12-aminododecanoie acids.

Advantageously, the polyamides of the second type are made of polyamide PA-11, polyamide PA-12 or polyamide PA-6.
According to a third type, the polyamides result from the condensation of at least one am-aminocarboxylie acid (or a lactam), at least one diamine and at least one dicarboxylic acid.

In this case, the polyamide PA blocks are prepared, during a first step, by polycondensation of:
the linear aliphatic or aromatic diamine or diamines having X carbon atoms;
the dicarboxylic acid or acids having Y carbon atoms; and
the comonomer or comonomers {Z}, chosen from lactams and am-aminocarboxylie acids having Z carbon atoms and the equimolar mixtures of at least one diamine having X1 carbon atoms and at least one dicarboxylic acid having Y1 carbon atoms, (X1, Y1) being different from (X, Y),
said comonomer or comonomers {Z} being introduced in a weight proportion ranging up to 50%, preferably up to 20%, even more advantageously up to 10% relative to the total of polyamide precursor monomers.

By way of example of an aliphatic α,ω-aminocarboxylic acid, mention may be of aminocaproic, 7-aminoheptanoic, 11-aminoundecanoie and 12-aminododecanoic acids.

By way of example of a lactam, mention may be made of caprolactam, oenanthollactam and lauryl lactam.

By way of example of aliphatic diamines, mention may be made of hexamethylenediamine, dodecamethylenediamine and trimethylhexamethylenediamine.

By way of example of cycloaliphatic diacids, mention may be made of 1,4-cyclohexyldiearboxylic acid.

By way of example of aliphatic diacids, mention may be made of butanedioic, adipic, azelaic, suberic, sebacic and dodecanedicarboxylic acids, dimerised fatty acids (these dimerised fatty acids preferably have a dimer content of at least 98%; preferably they are hydrogenated; they are sold under the brand name PRIPOL by Uniqema or under the brand name EMPOL by Henkel) and α,ω-polyoxyalkylene diacids.

By way of example of aromatic diacids, mention may be made of terephthalic (T) and isophthalic (I) acids.

By way of example of cycloaliphatic diamines, mention may be of the isomers of bis(4-aminocyclohexyl)methane (BALM), bis(3-methyl-4-aminocyclohexyl)methane (BMACM), and 2-2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

By way of example of polyamides of the third type, mention may be made of the following:
PA-6,6/6 in which 6,6 denotes hexamethylenediamine units condensed with adipic acid. 6 denotes units resulting from the condensation of caprolactam.
PA-6,6/Pip.10/12 in which 6,6 denotes hexamethylenediamine units condensed with adipic acid. Pip.10 denotes units resulting from the condensation of piperazine and sebacic acid. 12 denotes units resulting from the condensation of lauryl lactam. The weight proportions are respectively 25 to 35/20 to 30/20 to 30—the total being 80, and advantageously 30 to 35/22 to 27/22 to 27—the total being 80. For example the proportions 32/24/24 result in a melting point of 122 to 137° C.
PA-6,6/6,10/11/12 in which 6,6 denotes hexamethylenediamine condensed with adipic acid. 6,10 denotes hexamethylenediamine condensed with sebacic acid. 11 denotes units resulting from the condensation of aminoundecanoic acid. 12 denotes units resulting from the condensation of lauryl lactam. The weight proportions are respectively 10 to 20/15 to 25/10 to 20/15 to 25—the total being 70, and advantageously 12 to 16/18 to 25/12 to 16/18 to 25—the total being 70. For example, the proportions 14/21/14/21 result in a melting point of 119 to 131° C.
   The substrates (A) and (B) may be:
(a) identical, that is to say that the two substrates (A) and (13) are composed of the same polymer or polymers chosen from (i) polyamide (abbreviated to PA) homopolymers or copolymers, (ii) thermoplastic elastomers (abbreviated to TPEs), chosen from PEBAs or copolymers with polyamide blocks and polyether blocks, TPUs or thermoplastic polyurethane polymers, COPEs or copolymers having polyether blocks and polyester blocks and (iii) blends thereof; or
(b) different but are of the same nature, that is to say that the substrates (A) and (B) are both block copolymers with soft polyether blocks but with different hard blocks (e.g. the substrate (A) is made of PEBA and the substrate (B) is made of TPU; the substrate (A) is made of PEBA and the substrate (B) is made from COPE; the substrate (A) is made from TPU and the substrate (13) is made from COPE); or else
(c) different and of a different nature, that is to say that they fall neither into the category (a) nor into the category (b), (e.g. the substrate (A) is made of PEBA and the substrate (B) is made of leather; the substrate (A) is made from TPU and the substrate (B) is made of leather). In the latter case, when the substrate (A) is chosen from PAs and TPEs as defined previously, the substrate (B) is chosen from the substrates (D). Mention may be made, as substrate (D), of homopolymers or copolymers such as polyolefins, polyamines, polyesters, polyethers, polyimides, polycarbonates, phenolic resins, crosslinked or uncrosslinked polyurethanes, especially foams, poly(ethylene/vinyl acetates), natural or synthetic elastomers such as polybutadienes, polyisoprenes, styrene/butadiene/styrenes (SBSs), styrene/butadiene/acrylonitriles (SBNs), polyacrylonitriles and also natural or synthetic fabrics, especially fabrics made of organic polymer fibres such as fabrics made of polypropylene, polyethylene, polyester, polyvinyl alcohol, polyvinyl acetate, polyvinyl chloride or polyaramid fibres, fabrics made of glass fibres and carbon fibres, and also materials such as leather, paper and board; or
(d) different, one being made of PA, whereas the other is made of TPE. All these materials may also be in foam form when this is possible.

### Regarding the Laminates:

It is possible to have the options below in which primer (a) denotes an aqueous-type primer, primer (s) denotes an organic solvent-type primer.

The nature of the adhesive (E) depends on the nature of the substrate (B). It will be of aqueous type in the case where the substrate (13) is made of PA or of TPE and will be able to be of solvent type or of aqueous type, preferably of aqueous type in the other cases.

substrate (A)/primer (a)/aqueous adhesive (C)/adhesive (E)/primer (s)/substrate (B),

substrate (A)/primer (a)/aqueous adhesive (C)/adhesive (E)/primer (a)/substrate (B),

substrate (A)/primer (a)/aqueous adhesive (C)/adhesive (E)/substrate (B),

substrate (A)/aqueous adhesive (C)/adhesive (E)/primer (s)/substrate (B),

substrate (A)/aqueous adhesive (C)/adhesive (E)/primer (a)/substrate (B),

substrate (A)/aqueous adhesive (C)/adhesive (E)/substrate (B)

It is possible to have the following particularly advantageous and non-limiting options:

PA homopolymer or copolymer/primer (a)/aqueous adhesive (C)/aqueous adhesive (C)/primer (a)/PA homopolymer or copolymer,

PA homopolymer or copolymer/primer (a)/aqueous adhesive (C)/aqueous adhesive (C)/primer (a)/TPE,

TPE/primer (a)/aqueous adhesive (C)/aqueous adhesive (C)/primer (a)/TPE,

PA homopolymer or copolymer/primer (a)/aqueous adhesive (C)/aqueous adhesive (C)/primer (a)/polymer (D),

TPE/aqueous adhesive (C)/aqueous adhesive (C)/polymer (D),

PA homopolymer or copolymer/aqueous adhesive (C)/aqueous adhesive (C)/PA homopolymer or copolymer,

PA homopolymer or copolymer/aqueous adhesive (C)/aqueous adhesive (C)/TPE,

TPE/aqueous adhesive (C)/aqueous adhesive (C)/TPE,

PA homopolymer or copolymer/aqueous adhesive (C)/aqueous adhesive (C)/polymer (D),

TPE/aqueous adhesive (C)/aqueous adhesive (C)/polymer (D).

Mention may be made, for example, of:

PEBA/primer (a)/aqueous adhesive (C)/aqueous adhesive (C)/primer (a)/TPU,

PEBA/primer (a)/aqueous adhesive (C)/adhesive (E)/leather,

PEBA/primer (a)/aqueous adhesive (C)/adhesive (E)/polyurethane foam,

PEBA/primer (a)/aqueous adhesive (C)/adhesive (E)/rubber,

PEBA/primer (a)/aqueous adhesive (C)/adhesive (E)/polyolefin non-woven fabric,

PA/primer (a)/aqueous adhesive (C)/aqueous adhesive (C)/primer (a)/TPU,

PA/primer (a)/aqueous adhesive (C)/adhesive (E)/leather,

PA/primer (a)/aqueous adhesive (C)/adhesive (E)/polyurethane foam,

PA/primer (a)/aqueous adhesive (C)/adhesive (E)/rubber,

PA/primer (a)/aqueous adhesive (C)/adhesive (E)/polyolefin non-woven fabric,

TPU/primer (a)/aqueous adhesive (C)/aqueous adhesive (C)/primer (a)/TPU,

TPU/primer (a)/aqueous adhesive (C)/adhesive (E)/leather,

TPU/primer (a)/aqueous adhesive (C)/adhesive (E)/polyurethane foam,

TPU/primer (a)/aqueous adhesive (C)/adhesive (E)/rubber,

TPU/primer (a)/aqueous adhesive (C)/adhesive (E)/polyolefin non-woven fabric.

The substrate layers generally have a thickness of 0.4 to 5 mm.

### Regarding the Exudation

The detection of an exudate which is not always easy to observe visually, its quantification and optionally its identification may be carried out by infrared spectroscopy by means of the surface analysis technique known as single-reflection ATR.

The presence of an exudate is defined at the surface of a polymer part (sheet, shoe sole component, etc.) when, after having been placed in intimate contact with the surface of the germanium crystal of the single-reflection ATR device, then withdrawn from the crystal, the part leaves a deposit on the latter from which it is possible to obtain the infrared spectrum. Strictly speaking, there is exudation when an infrared spectrum is obtained of which the intensity of the peaks is greater than two times the background noise, which corresponds to the detection limit of the infrared spectrometer. The germanium ATR crystal makes it possible to analyse deposits having a very small thickness (a fraction of a micron) and the greater or lesser amount of exudate may be estimated from the intensity of the lines expressed as Optical Density (OD) of the infrared spectrum after subtracting a blank spectrum. The higher the spectral bands are relative to the background noise, the larger the exudate. A grade of exuding polymer is defined here when, by following the method described below, a deposit is obtained on the ATR crystal of which the infrared signal has lines of intensity greater than 0.005 of optical density.

### Regarding the Process for Manufacturing the Laminate

The process for manufacturing a laminate, according to the present invention, comprises the following steps:

(a) optionally a step of pre-cleaning the layer of substrate (A) and/or the layer of substrate (B), in the form of pre-cleaning by an oxidizing or reducing continuous atmospheric cold plasma treatment;
(b) a step of activation by continuous atmospheric cold plasma treatment of the layer of substrate (A) and/or of the layer of substrate (B), said plasma being either:
(i) oxidizing or reducing, in the case where said layer is made from a polymer having a Shore D hardness strictly between 35 and 60 or in the case where said layer is made from a polymer having a Shore D hardness > or =60 and a distance between the plasma source and the surface of the layer to be activated < or =3 cm; or
(ii) reducing in the case where said layer is made from a polymer having a Shore D hardness > or =60 and a distance between the plasma source and the surface of said layer to be activated >3 cm;
   (c) optionally an adhesive coating step of the layer of substrate (A) and/or of the layer of substrate (B) using an aqueous primer;
   (d) an adhesive coating step of said layer of substrate (A) and/or of said layer of substrate (B) using an aqueous adhesive (C);
   (e) a step of contacting the layers of substrates (A) and (B) so as to form a laminate;
   (f) a step of pressing the assembly obtained in (e), in a moist atmosphere; and
   (g) after removal from the press, the recovery of the laminated product.

The pressure applied during the pressing step is 1 to 15 kg/cm², preferably 3 to 10 kg/cm², and the temperature is 20° C. to 150° C. The presses used in the process of the invention are conventional presses in the field of manufacturing laminates.

The moist atmosphere is preferably air having a relative humidity RH≧5%, preferably RH≧10% and better still RH≧20%.

The Cold Plasma Treatment

A plasma is an electrically neutral gas of which the species, atoms or molecules, are excited and/or ionized. A cold plasma is an ionized gas, in a state of thermodynamic disequilibrium, of which only the electrons are raised to a high temperature, the other particles (ions, radicals, fragments of neutral stable molecules) remain at ambient temperature. Unlike thermal plasmas used in high-temperature spraying, cold plasmas are medians that enable surface modifications (deposits, grafting, etching, etc.) at low temperature, without damaging the substrates. The plasma is generated in a field chamber, under partial vacuum or at atmospheric pressure, into which a plasma gas is injected. It is possible to generate a plasma by transferring energy to this gas by the action of an electrical discharge. A discharge is a rapid conversion of electrical energy to kinetic energy, then to energy for excitation and ionization of atoms and molecules.

The electrical energy supplied to the system is partly converted by the charged particles thus formed (electrons, ions) to kinetic energy. Due to their low mass, the free electrons generally recover most of this energy and cause, by collision with the heavy particles of the gas, their excitation or dissociation and therefore they sustain the ionization.
The plasma treatment is mostly used to improve the wetability (surface energy), the adhesion characteristics (inks, adhesives, etc.) or even non-stick characteristics, and the biocompatibility of the surface of the polymers. It is also used as a means for cleaning and crosslinking surface layers of the polymer.
The bombardment of the surface of the polymers by the energetic species created within the plasma results in the breaking of covalent bonds (cutting of macromolecular chains) and the formation of free radicals. The latter react with the active species of the plasma whence it results, at the surface of the materials, in the formation of functional chemical groups that depend on the nature of the gas phase. This is then referred to as surface activation or functionalization.

1. Oxidizing Plasmas

The oxidizing plasmas (O₂, CO₂, H₂O, etc.) give rise to the formation of oxygenated (hydroxyl, carbonyl, carboxyl, peroxide, hydroperoxide, carbonate, etc.) functional groups. The functionalization of the surfaces by hydrophilic groups of this type makes it possible to increase their wettability and in principle their adhesivity.

2. Reducing Plasmas

Similarly, reducing plasmas (N₂, N₂H₂, NH₃, etc.) give rise to the formation of hydrophilic groups, in particular amine groups (—NH, —NH₂; in the case of NH₃ plasmas) or even amide groups (—N—C═O). It should be noted that oxygenated groups are always present at the surface of polymer materials treated in a nitrogen-containing plasma. This is because the free radicals created at the surface of these materials react with the residual oxygenated species present in the reactor during the plasma treatment. Likewise, the free radicals still present at the surface of the materials after the treatment react with oxygen from the atmosphere after the treated samples are put back in air. Obviously, plasma treatments in an NO or NO₂ atmosphere also give rise to the formation of the nitrogen-containing and oxygen-containing groups.

3. Plasma Pre-Cleaning of Surfaces

Oxidizing and reducing plasmas and in particular O₂ plasmas are commonly used to remove traces of organic contaminants at the surface of polymer substrates and also weakly bonded fragments of the polymer (oligomers) present at the surface of these same substrates. This is referred to as plasma precleaning. It is a plasma treatment as described previously. The plasma oxidation results in the dissociation of these species and in the desorption of volatile compounds (CO, CO₂, H₂O, etc.) which are removed by the pumping systems of the reactor.

The examples below illustrate the present invention without limiting the scope thereof. In the examples, except where indicated otherwise, all the percentages and parts are expressed by weight.

The Pebax 55 and Pebax 70 used denote copolymers having polyamide blocks and polyether blocks of which the characteristics are given in Table I below. These are PEBAs composed of alternate blocks made of PA 12 and of PTMG.

TABLE I

PEBAX ®

| | 55 | 70 |
|---|---|---|
| MFI (g/10 min) | 3/10 | 3/7 |
| Min. viscosity | 1.43 | 1.33 |
| Max. viscosity | 1.58 | 1.48 |
| Density | 1.01 | 1.02 |
| DSC (° C.) | 159 | 172 |
| Cryst. Temp (° C.) | 110 | 121 |
| 23° C./65% RH H²O abs. (%) | 0.5 | 0.6 |
| Vicat (1 daN) (° C.) | 144 | 165 |
| Flex. mod. (MPa) | 170 | 430 |
| Tensile mod. (MPa) | 160 | 383 |
| Shore D hardness | 55 | 69 |
| (70° C.) compression set (%) | 20 | 5 |
| 0.46 MPa HDT (° C.) | 66 | 99 |

### Methodology for Measurement of the Exudate at the Surface of a Polymer:

1) Equipment:

TF-IR machine equipped with a single-reflection ATR accessory with a germanium crystal: Nicolet 460 ESP spectrophotometer (Thermo Fisher) equipped with a Thunderdome (Spectra-Tech) accessory with a germanium crystal.
The germanium enables analysis to a depth of around one micron. It is therefore suitable for the analysis of very small deposits.

2) Procedure:

Place the surface of the sample to be analysed against the germanium crystal.
Carry out 5 successive pressing operations using a pressure tower, moving the sample by a few mm each time.
Remove the sample and carry out the spectrum of the deposit.

Spectral conditions:

experiment: Thunderdome;

number of scans: 64;

resolution: 4 cm-1;

correction: ATR;

zero filling: 2 levels;

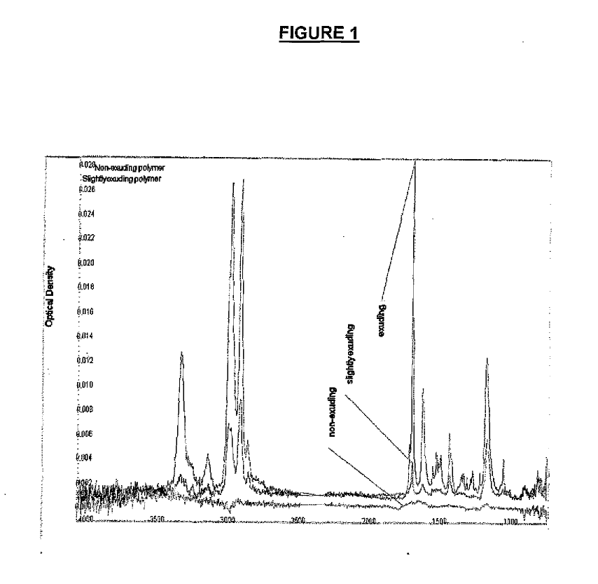

the blank spectrum was carried out with the crystal on its own.
The deposit or exudate spectra were measured on a non-exuding, weakly exuding and exuding polymer (see FIG. 1).

### METHOD OF PRODUCING THE EXAMPLES (EX) AND COMPARATIVE EXAMPLES (CP)

The PEBAX 55 and 70 described above may additionally be of various types that are defined below. These are:
type 1: PEBAX 70-1 and PEBAX 55-1 do not contain stabilizers;
type 2: PEBAX 70-2 and PEBAX 55-2 contain a formulation of stabilizers which do not exude at the surfaces of the bars; and
type 3: PEBAX 70-3 and PEBAX 55-3 contain a formulation of stabilizers that exude at the surface of the bars.
   Laminates were produced by proceeding in the following manner:
optionally an N₂/O₂ plasma precleaning was carried out in the case of Example 24 or a chemical precleaning with MEK in the case of Comparative example 22 or a precleaning with soapy water in the case of Comparative example 23;
activation of the substrate (A) by atmospheric plasma treatment indicated in Table II below;
a layer of aqueous primer (Dongsung W104®) was applied with a brush to the surface of the substrate (A) intended to be attached and it was dried in a ventilated oven (5 minutes at 70° C.);
an aqueous adhesive (Dongsung W-01®) was applied to the surface of the substrate (A) previously treated with aqueous primer and it was dried in a ventilated oven (5 minutes at 70° C.);
the substrate (B) was precleaned with MEK;
a layer of solvent-based primer (Dongsung 171-2®) was applied with a brush to the surface of substrate (B) intended to be attached and it was dried in a ventilated oven (3 minutes at 70° C.);
an aqueous adhesive (Dongsung W-01®) was applied to the surface of the substrate (B) previously coated with the solvent-based primer and it was dried in a ventilated oven (5 minutes at 70° C.); and
the two substrates were contacted at their adhesive-coated surfaces and the assembly was placed in a press, in air, for 1 minute at a pressure of 4 bar and at ambient temperature.
   The thickness of the adhesive joint (the adhesive layers+the primer layers) varied between 50 and 150 μm.
   The geometry of the final laminate was the following:

### Width=15 mm, Length=100 mm, Thickness=2 to 5 mm.

The parameters relating to the laminates (Examples and Comparative examples) and also the results of the peel tests (standard ISO 11339, rate: 100 mm/minute) are given in Table II.

TABLE II

| | Substrates | | Type of | Distance between | Peel |
|---|---|---|---|---|---|
| Lami- | Substrate | Substrate | plasma | source and | strength |
| nates | nature (A) | nature (B) | treatment | sample (mm) | (kg/cm) |
| Ex5 | Pebax ® | Pebax ® | N₂/H₂ | 2-5 | >5 |
| | 70-1 | 55-1 | | | |
| Cp9 | Pebax ® | Pebax ® | N₂ | 2-5 | <3 |
| | 55-3 | 55-1 | | | |
| Cp12 | Pebax ® | Pebax ® | N₂/H₂ | 6 | <5 |
| | 70-3 | 55-1 | | | |
| Ex13 | Pebax ® | Pebax ® | N₂/H₂ | 6 | >5 |
| | 70-2 | 55-1 | | | |
| Ex14 | Pebax ® | Pebax ® | N₂/H₂ | 10 | >5 |
| | 70-2 | 55-1 | | | |
| Ex15 | Pebax ® | Pebax ® | N₂/H₂ | 20 | >5 |
| | 70-2 | 55-1 | | | |
| Ex16 | Pebax ® | Pebax ® | N₂/H₂ | 30 | >5 |
| | 70-2 | 55-1 | | | |
| Ex17 | Pebax ® | Pebax ® | N₂/H₂ | 40 | >5 |
| | 70-2 | 55-1 | | | |
| Ex7 | Pebax ® | Pebax ® | N₂ | 2-5 | >5 |
| | 55-1 | 55-1 | | | |
| Ex8 | Pebax ® | Pebax ® | N₂/O₂ | 2-5 | >5 |
| | 55-1 | 55-1 | | | |
| Ex18 | Pebax ® | Pebax ® | air | 5 | >5 |
| | 70-2 | 55-1 | | | |
| Ex19 | Pebax ® | Pebax ® | air | 10 | >5 |
| | 70-2 | 55-1 | | | |
| Ex20 | Pebax ® | Pebax ® | air | 35 | <2 |
| | 70-2 | 55-1 | | | |
| Cp22 | Pebax ® | Pebax ® | N₂/H₂ | 20 | <3 |
| | 70-2* | 55-1 | | | |
| Cp23 | Pebax ® | Pebax ® | N₂/H₂ | 20 | <3 |
| | 70-2* | 55-1 | | | |
| Cp24 | Pebax ® | Pebax ® | N₂/H₂ | 20 | >5 |
| | 70-2* | 55-1 | | | |
| Ex25 | AESNO | Pebax ® | N₂/H₂ | 6 | >5 |
| | TL ® | 55-1 | | | |

*contaminated by a mould release agent introduced into the mould before injection of the polymer into said mould.

The results show that whatever the hardness of the Pebax® used, high peel strengths are obtained which are much higher than 3 daN/cm due to the process for manufacturing laminates according to the invention.

1. Process for manufacturing a laminate comprising at least two polymer layers, a layer (A) and a layer (B) attached to one another by at least one layer of an aqueous-type adhesive polymer material (C), comprising the steps of
(a) optionally precleaning the layer of substrate (A) and/or the layer of substrate (B), by an oxidizing or reducing continuous atmospheric cold plasma treatment;
(b) activating by continuous atmospheric cold plasma treatment the layer of substrate (A) and/or of the layer of substrate (B), said plasma being either:
(i) oxidizing or reducing, in the case where said layer is made from a polymer having a Shore D hardness strictly between 35 and 60 or in the case where said layer is made from a polymer having a Shore D hardness > or =60 and a distance between the plasma source and the surface of the layer to be activated < or =3 cm;
(ii) reducing in the case where said layer is made from a polymer having a Shore D hardness > or =60 and a distance between the plasma source and the surface of said layer to be activated >3 cm;
(c) optionally coating the layer of substrate (A) and/or the layer of substrate (B) with an adhesive coating, using an aqueous primer;
(d) coating of said layer of substrate (A) and/or said layer of substrate (B) with an aqueous-type adhesive polymer material (C);
(e) contacting the layers of substrates (A) and (B), and
(f) pressing the assembly obtained in step (e), in a moist atmosphere so as to form the laminate,
wherein the layer of substrate (A) comprises one or more polymers, to which at least one filler may optionally, said polymer or polymers being chosen from polyamides, thermoplastic elastomers (TPEs) and blends thereof,
wherein the layers of substrates (A) and (B) are identical or different, and wherein the layers of substrates (A) and (B) are made with non-exuding polymers.

2. Process according to claim 1, wherein the substrates (A) and (13) are identical, and composed of the same polymer or polymers chosen from (i) polyamide (PA) homopolymers or copolymers, (ii) thermoplastic elastomers (TPEs), wherein said TPE is selected from the group consisting of copolymers with polyamide blocks and polyether blocks (PEBAs), thermoplastic polyurethane polymers (TPUs), and copolymers having polyether blocks and polyester blocks (COPEs), and (iii) blends thereof.

3. Process according to claim 1, wherein the substrates (A) and (B) are both block copolymers with soft polyether blocks but with different hard blocks.

4. Process according to claim 1, wherein the substrates (A) and (B) are different and are of a different nature, substrate (A) being chosen from PAs and TPEs and substrate (B) being chosen from the substrates (D) the substrates (D) selected from the group consisting of polyolefins, polyamines, polyesters, polyethers, polyimides, polycarbonates, phenolic resins, crosslinked or uncrosslinked polyurethanes, polyurethane foams, poly(ethylene/vinyl acetates), natural elastomers, synthetic elastomers, polybutadienes, polyisoprenes, styrene/butadiene/styrenes (SBSs), styrene/butadiene/acrylonitriles (SBNs), polyacrylonitriles; (ii) natural or synthetic fabrics; fabrics made of organic polymer fibres; fabrics made of polypropylene, polyethylene, polyester, polyvinyl alcohol, polyvinyl acetate, polyvinyl chloride or polyaramid fibres fabrics made of glass fibres, fabrics made of carbon fibres; leather, paper and board.

5. Process according to claim 1, wherein the substrates (A) and (B) are different, one being made of PA, whereas the other is made of TPE.

6. Process according to claim 1, wherein said TPEs are chosen from the group consisting of PEBAs, TPUs, COPEs and copolymers having polyether blocks and polyester blocks.

7. Process according to claim 1, wherein the adhesive polymer material (C) is a crosslinkable hot-melt material manufactured by the reaction of at least one functionalized prepolymer and at least one curing agent having free (—N═C═O) or blocked isocyanate functional groups.

8. Process according to claim 7, wherein the content of the curing agent having free or blocked isocyanate functional groups represents 0.5 to 25% by weight relative to the total weight of the functionalized prepolymer.

9. Process according to claim 7, wherein the functionalized prepolymers are chosen from hydroxylated polyesters, hydroxylated polyethers and blends thereof.

10. Process according to claim 1, wherein the laminates are chosen from the structures:
substrate (A)/primer (a)/aqueous adhesive (C)/adhesive (E)/primer (s)/substrate (B),
substrate (A)/primer (a)/aqueous adhesive (C)/adhesive (E)/primer (a)/substrate (B),
substrate (A)/primer (a)/aqueous adhesive (C)/adhesive (E)/substrate (B),
substrate (A)/aqueous adhesive (C)/adhesive (E)/primer (s)/substrate (B),
substrate (A)/aqueous adhesive (C)/adhesive (E)/primer (a)/substrate (B), and
substrate (A)/aqueous adhesive (C)/adhesive (E)/substrate (B)
the primer (a) denoting an aqueous-type primer,
the primer (s) denoting an organic solvent-type primer,
the aqueous adhesive (C) denoting the aqueous-type adhesive polymer material (C), and the adhesive (E) denoting an aqueous-type adhesive or an organic solvent-type adhesive.

11. Process according to claim 10, wherein the adhesive (E) is of aqueous type in the case where the substrate (B) is made from PA or from TPE and is of solvent type or of aqueous type, preferably of aqueous type in the other cases.

12. Process according to claim 10, wherein the laminates are chosen from the structures:
PA homopolymer or copolymer/primer (a)/aqueous adhesive (C)/aqueous adhesive (C)/primer (a)/PA homopolymer or copolymer,
PA homopolymer or copolymer/primer (a)/aqueous adhesive (C)/aqueous adhesive (C)/primer (a)/TPE,
TPE/primer (a)/aqueous adhesive (C)/aqueous adhesive (C)/primer (a)/TPE,
PA homopolymer or copolymer/primer (a)/aqueous adhesive (C)/aqueous adhesive (C)/primer (a)/polymer (D),
TPE/aqueous adhesive (C)/aqueous adhesive (C)/polymer (D),
PA homopolymer or copolymer/aqueous adhesive (C)/aqueous adhesive (C)/PA homopolymer or copolymer,
PA homopolymer or copolymer/aqueous adhesive (C)/aqueous adhesive (C)/TPE,
TPE/aqueous adhesive (C)/aqueous adhesive (C)/TPE,
PA homopolymer or copolymer/aqueous adhesive (C)/aqueous adhesive (C)/polymer (D),
TPE/aqueous adhesive (C)/aqueous adhesive (C)/polymer (D),
PEBA/primer (a)/aqueous adhesive (C)/aqueous adhesive (C)/primer (a)/TPU,
PEBA/primer (a)/aqueous adhesive (C)/adhesive (E)/leather,
PEBA/primer (a)/aqueous adhesive (C)/adhesive (E)/polyurethane foam,
PEBA/primer (a)/aqueous adhesive (C)/adhesive (E)/rubber, and
PEBA/primer (a)/aqueous adhesive (C)/adhesive (E)/polyolefin non-woven fabric.

13. Process for manufacturing a constituent component of a shoe comprising the process of claim 1 and further comprising the step of forming said laminate into a constituent component of a shoe.

14. Manufacturing process according to claim 13, wherein the constituent component is a sole of a shoe

15. Manufacturing process according to claim 14, wherein said sole comprises a sports shoe sole.
